(19) United States
(12) Patent Application Publication
(10) Pub. No.: US 2024/0111796 A1
(43) Pub. Date: Apr. 4, 2024

(54) HELPING PROSPECTIVE MOVERS INTERACTIVELY DISCOVER AND EXPLORE PERSONALIZED LIVING LOCATIONS

(71) Applicant: Where Might I Live LLP, Post Falls, ID (US)

(72) Inventors: Richard Heggem, Post Falls, ID (US); Steve Harshbarger, Mill Valley, CA (US)

(21) Appl. No.: 18/374,919

(22) Filed: Sep. 29, 2023

Related U.S. Application Data
(60) Provisional application No. 63/412,185, filed on Sep. 30, 2022.

(51) Int. Cl. G06F 16/33; G06F 16/332; G06F 16/338

(52) U.S. Cl. CPC G06F 16/334; G06F 16/3322; G06F 16/3334; G06F 16/338

(57) ABSTRACT

A system for assisting prospective movers in interactively finding locations compatible with their needs and interests. In one aspect, the system helps prospective movers discover conscious and subconscious needs and interests. In one aspect, the system helps prospective movers define the limits or boundaries of their needs and interests. In one aspect, the system helps prospective movers discover the limits or boundaries of their needs and interests. In one aspect, the system helps prospective movers discover locations matching or closely matching their needs and interests. In one aspect, the system allows a prospective mover to specify profiles containing their associated customized needs and interests. In one aspect, the system allows a prospective mover to specify profiles containing their associated customized favorite locations. In one aspect, the system allows a prospective mover to broadcast their customized needs and interests to others to obtain feedback. In one aspect, the system allows a prospective mover to broadcast their customized favorite locations to others to obtain feedback. In one aspect, the system ranks locations based on prospective mover-specified filter criteria. In one aspect, the system notifies a prospective mover about newly received information updates or services related to the prospective mover, their needs, interests, or favorite locations.

### BENEFIT CLAIM

This application claims the benefit as a provisional application 63/412,185, filed Sep. 30, 2022, by Richard Heggem et al., the entire contents of which is hereby incorporated by reference. The applicant hereby rescinds any disclaimer of claim scope in the parent applications or the prosecution history thereof and advise the USPTO that the claims in this application may be broader than any claim in the parent application.

### FIELD

The present application relates generally to information management systems and, more specifically, to a machine-implemented architecture for helping prospective movers interactively discover and explore personalized living locations.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Tens of millions of people relocate in America every year. More than ⅓ of all Americans don't live in their birth state. The average American moves 11.7 times in their life.

Best-selling author Richard Florida stresses the importance of where we live when he writes, “The place we choose to live affects every aspect of our being. It can determine the income we earn, the people we meet, the friends we make, the partners we choose, and the options available to our children and families. People are not equally happy everywhere, and some places do a better job of providing a high quality of life than others.”

Dr. Florida further observes, “The stakes are high, and yet, when faced with the decision of where to call home, most of us are not prepared to make the right choice. If you ask most people how they got to the place they live now, they'll say they just ended up there . . . Some don't even see that there's a choice to be made at all.”

Deciding where to move is a complex exercise, wrought with decision fatigue for many. And no wonder since there are scores or hundreds of attributes to consider when making a move. Considerations about crime, demographics, economics, schools, pollution, access to medical care, housing, natural disasters, politics, population, proximity to family, religion, taxes, transportation, weather, and others should all be considered by prudent people. And yet, the effort required to collect this information for every possible place to live, along with so many other attributes (e.g., golf, fishing, dining, arts and entertainment, etc.), make this a nearly impossible task for the average person. Even if the information was readily available, which it frequently is not, assembling it all into an actionable form could become a full-time occupation.

The complexity described above is further heightened by the fact that most people don't know even the attributes that are important to them. Asking them what's important to them in a new location often elicits a blank stare and the most simplistic response, such as “I just don't want to live in the snow,” as if that is the only attribute. Does that mean they are OK with living in the “tornado belt,” in a flood zone, or a high crime area? Of course not. It's just that all those attributes, as important as they are to the prospective mover, are not “on their radar.” That is, they are utterly unaware of attributes that are critically important to them, were they aware.

The preceding complexities and decision fatigue have made many susceptible to the proliferation of articles and videos on the topic of “The 25 Best Places to Live in America,” or similar. There are hundreds of such pieces of content, many published by leading media outlets. Of course, such articles are fantasies unless the reader/viewer of the article/video has the exact needs and interests as the author/publisher—which is highly unlikely. Logically, there is no “THE best place” for everyone. However, there is “A best place” for each person.

Interest in moving is often accelerated by changing circumstances or changing technology. For example, during the Covid experience in 2020 and 2021, 46 million Americans reassessed where they lived. And the broad emergence of remote working, resulting from the Covid lockdowns, opened the door to relocation where it was previously unthinkable.

According to author Melody Warnick, there are 117 million “anywhereists” in America—people who could live and work anywhere. Anywhereists include not just remote workers but also transferrable career workers like doctors, lawyers, and teachers.

The old saying, “It looks good on paper,” applies to relocation. Even if a prospective mover's preferences are met “on paper” (stage 1), they still need to confirm the decision, most often by a visit to the location and further investigation (stage 2). To complete stage 2, additional resources are required, including access to local news, advisement by professional service providers (e.g., realtors or movers), travel services (e.g., hotels, flights, cars, etc.), and the advice or experiences of others who live or lived at the desired location.

Based on the preceding, an approach for helping prospective movers interactively discover and explore ideal personalized living locations that does not suffer from limitations in prior approaches is highly desirable.

### SUMMARY

A system and architecture for helping prospective movers interactively discover and explore ideal personalized living locations is disclosed. In one aspect, the system includes a mechanism for educating, via an Internet-based system, about the many location attributes people may want to consider when contemplating a prospective move.

In one aspect, the system includes a mechanism that categorizes quantitative data for each location. In one aspect, the quantitative data may be categorized into topics such as arts & entertainment, crime, demographics, politics, weather, and others. In one aspect, the quantitative data categories may be further categorized into subcategories, or attributes, such as violent crime, property crime, or homicide.

In one aspect, the system includes a mechanism that categorizes qualitative data for each location. In one aspect, the qualitative data may include images depicting the location. In one aspect, the qualitative data may include hyperlinks to local news and information sources for each location. In one aspect, the qualitative data may include notable facts about the location or notable people associated with the location. In one aspect, the qualitative data may include information about or links related to events occurring in the location. In one aspect, the qualitative data may include information about or links related to resources or services that may help the prospective mover further explore the location.

In one aspect, the system includes a mechanism that displays the range of values for the quantitative data attributes for each location or for all the locations collectively.

In one aspect, the system includes a mechanism allowing prospective movers to establish desirable limits on attributes of their choosing.

In one aspect, the system includes a mechanism combining the prospective mover's chosen attributes to establish a ranked list of all the locations, the ranking of which depicts those locations that best satisfy the needs and interests of the prospective mover.

In one aspect, the system includes a mechanism to present the attribute values in an absolute fashion. In one aspect, the system includes a mechanism to present the attribute values in a relative fashion compared to the typical or average values.

In one aspect, the system includes a mechanism to isolate and display single attributes even when several attributes are selected as important. In one aspect, the isolated attributes may be independently and dynamically modified by the prospective mover.

In one aspect, the system includes a mechanism to amplify the weighting of select attributes that are more important than others in the perception of the prospective mover. Through the Internet-based system, the reweighting of select attributes will alter the ranking of the various locations for the prospective mover.

In one aspect, the system includes a mechanism to allow the prospective mover to select and isolate favorite locations.

In one aspect, the system includes a mechanism to allow the prospective mover to isolate and display locations that completely meet the needs and interests of the prospective mover by virtue of those locations being within the limits of the prospective mover's selected attributes. In one aspect, the system includes a mechanism to allow the prospective mover to display locations that partially meet the needs and interests of the prospective mover on a ranked basis in accordance with how well each location meets the needs and interests of the prospective mover as identified with how far out of bounds each location's attributes are with respect to the limits established by the prospective mover. In one aspect, the system includes a mechanism to reference as “close matches” those locations that are within a specific range of being a complete match.

In one aspect, the system includes a mechanism to allow the prospective mover to create a profile that includes their ranked location list and favorite locations. In one aspect, the system includes a mechanism to allow the prospective mover to create multiple profiles, each possibly including different location ranks and different favorites based on different selections by the prospective mover.

In one aspect, the system includes a mechanism to allow the prospective mover to identify their current living location. In one aspect, the system includes a mechanism to score the current living location in accordance with how well said location meets the attributes and limits established by the prospective mover. In one aspect, the system includes a mechanism to rank the current living location compared to all the other locations.

In one aspect, the system includes a mechanism to allow the prospective mover to share elements of their profile. In one aspect, the system includes a mechanism to allow the prospective mover to share elements of their profile on social media. In one aspect, the system includes a mechanism to allow the prospective mover to share elements of their profile via email. In one aspect, the system includes a mechanism to allow the prospective mover to share their favorite locations. In one aspect, the system includes a mechanism to allow the prospective mover to share their location ranks. In one aspect, the system includes a mechanism to allow the prospective mover to share their select attributes and limits.

In one aspect, the system includes a mechanism to allow the prospective mover to identify and select multiple reference locations. In one aspect, the system includes a mechanism to compare and correlate all attributes of the reference locations. In one aspect, the system displays the correlation between all the reference locations so that the prospective mover can identify common attributes. In one aspect, the system includes a mechanism allowing the prospective mover to select the correlated attributes most meaningful to the prospective mover. In one aspect, the system includes a mechanism that establishes limits for each of the selected correlated attributes based on the quantitative attribute values of all of the reference locations. In one aspect, the system includes a mechanism that displays all of the other locations that are within the automatically established limits of the selected correlated attributes. In one aspect, the system includes a mechanism that displays all of the “close match” locations in accordance with the description of “close match” mentioned earlier. In one aspect, the system includes a mechanism that displays all of the locations in rank order as established by how well they satisfy the automatically established limits of the selected correlated attributes.

### BRIEF DESCRIPTION OF THE DRAWINGS

Implementations are depicted by way of example, and not by way of limitation, in the figures of the accompanying drawings and in which like reference numerals refer to similar elements and in which:

FIG. 1 is a block diagram that depicts a system for helping prospective movers interactively discover and explore ideal personalized living locations, in accordance with an implementation.

FIG. 2A is a block diagram that depicts front-end application components for helping prospective movers interactively discover and explore ideal personalized living locations, in accordance with an implementation.

FIG. 2B is a block diagram that depicts server components for helping prospective movers interactively discover and explore ideal personalized living locations, in accordance with an implementation.

FIG. 3 is a block diagram of a ranking engine that depicts an approach for a ranking personalized location matches, in accordance with an implementation.

FIG. 4 is a block diagram of a correlation engine that depicts an approach for correlating attributes for multiple locations favored by a prospective mover, in accordance with an implementation.

FIG. 5 is a block diagram that depicts an approach for enhancing system performance, in accordance with an implementation.

FIG. 6 is a flow diagram that depicts an approach for finding best match locations through the use of attribute selection and limit setting, in accordance with an implementation.

FIG. 7 is a flow diagram that depicts an approach for finding best match locations through the use of reference locations and automatic limit setting, in accordance with an implementation.

FIG. 8A is a depiction of a slider control approach for establishing attribute limit ranges, in accordance with an implementation.

FIG. 8B is a depiction of a toggle filter control approach for establishing attribute limits, in accordance with an implementation.

FIG. 8C is a depiction of a ladder filter control approach for establishing attribute limits, in accordance with an implementation.

FIG. 9A is a depiction of a map view colorized to display best-match locations in accordance with an implementation.

FIG. 9B is a depiction of a list view colorized and ranked to display best-match locations in accordance with an implementation.

FIG. 9C is a depiction of a location profile with both qualitative and quantitative data to characterize the location and present links for further exploration in accordance with an implementation.

FIG. 9D is a depiction of a location profile with exploration-enhancing advertisements in accordance with an implementation.

FIG. 10A is a depiction of a colorized heatmap to display the variability of a given attribute in accordance with an implementation.

FIG. 10B is a depiction of a list view of the heatmap results displayed in rank order in accordance with an implementation.

FIG. 11A is a display of a map depicting a prospective mover's favorite locations in accordance with an implementation.

FIG. 11B is a display of a list depicting a prospective mover's favorite locations in accordance with an implementation.

FIG. 12A is a display of a user interface with an option to isolate a single attribute and its control for modification in accordance with an implementation.

FIG. 12B is a display of a user interface isolating a single attribute and providing control for its modification in accordance with an implementation.

FIG. 13A is a display of a user interface with an option to allow attributes to be more highly weighted in the best location match rankings in accordance with an implementation.

FIG. 13B is a display of a user interface whereby some attributes have been more highly weighted in the best location match rankings in accordance with an implementation.

FIG. 14A is a display of a user interface allowing prospective mover's experience to be shared with others in accordance with an implementation.

FIG. 14B is a display of a user interface allowing attributes or favorites to be shared through different media channels in accordance with an implementation.

FIG. 14C is a display of a user interface allowing sharees to have a read-only experience of the original prospective mover's account in accordance with an implementation.

FIG. 15 is a display of a user interface allowing prospective movers to see the score and rank of their current living location, their reference locations, and their favorite locations in accordance with an implementation.

FIG. 16 is a block diagram that illustrates a computer system upon which an implementation may be implemented.

### DETAILED DESCRIPTION

A method and apparatus for helping prospective movers interactively discover and explore ideal personalized living locations is described. In the following description, for the purposes of explanation, numerous specific details are set forth in order to provide a thorough understanding of various implementations. It will be apparent, however, that the present invention may be practiced without these specific details. In other instances, well-known structures and devices are shown in block diagram form in order to avoid unnecessarily obscuring the present invention. In some instances, flow diagrams are used to depict steps performed in various implementations. The invention is not limited to the particular order of steps depicted in the figures and the order may vary, depending upon the requirements of a particular implementation. Furthermore, steps that are depicted and described may be removed and/or other steps may be added, depending upon the requirements of a particular implementation. Various aspects are described hereinafter in the following sections:
I. OVERVIEW
II. SYSTEM ARCHITECTURE OVERVIEW
III. PERSONALIZATION BY LOCATION ATTRIBUTES
IV. ALLOWING USERS TO ESTABLISH LIMITS ON THEIR DESIRED ATTRIBUTES
IV. CATEGORIZING THE QUALITATIVE AND QUANTITATIVE MEASURES FOR VARIOUS LOCATIONS
V. COMPARING ATTRIBUTE VALUES AGAINST A TYPICAL NORM
VI. ALLOWING USERS TO COMBINE ATTRIBUTES, RESULTING IN A RANKED LIST OF LOCATIONS
VII. INCREASED WEIGHTING OF USER-SELECTED CRITICALLY IMPORTANT ATTRIBUTES
VIII. ALLOWING USERS TO USE DESIRABLE REFERENCE LOCATIONS TO DISCOVER MORE LOCATIONS SHARING THE SAME ATTRIBUTES
IX. RANKING AND DISPLAYING CLOSE MATCHES
X. CATEGORIZING THE QUALITATIVE AND QUANTITATIVE MEASURES AS DESCRIPTORS FOR LOCATIONS
XI. MONETIZING VIA EXPLORATION ENHANCING ADVERTISEMENTS
XII. COMPARATIVELY DISPLAYING THE VALUE RANGES FOR THE VARIOUS ATTRIBUTES VIA HEATMAPS
XIII. ALLOWING USERS TO SELECT FAVORITES
XIV. ISOLATING ATTRIBUTES TO ALLOW DYNAMIC SELECTION OF LIMITS
XV. ALLOWING USERS TO CREATE PROFILES, INCLUDING THEIR RANKED LOCATION LISTS AND FAVORITES
XVI. ALLOW USERS TO “SCORE” AND RANK THEIR CURRENT LIVING LOCATION FOR USE AS A REFERENCE
XVII. ALLOWING USERS TO SHARE THEIR PROFILES
XVIII. IMPLEMENTATION MECHANISMS, ALTERNATIVES & EXTENSIONS

### I. Overview

A system and architecture for helping prospective movers interactively discover and explore personalized living locations is disclosed. In one aspect, the system includes a mechanism for educating, via an Internet-based system, about the many location attributes people may want to consider when contemplating a prospective move.

In one aspect, the system includes a mechanism that categorizes quantitative data for each location. In one aspect, the quantitative data may be categorized into topics such as arts & entertainment, crime, demographics, politics, weather, and others. In one aspect, the quantitative data categories may be further categorized into subcategories, or attributes, such as violent crime, property crime, or homicide.

In one aspect, the system includes a mechanism that categorizes qualitative data for each location. In one aspect, the qualitative data may include images depicting the location. In one aspect, the qualitative data may include hyperlinks to local news and information sources for each location. In one aspect, the qualitative data may include notable facts about the location or notable people associated with the location. In one aspect, the qualitative data may include information about, or links related to, events occurring in the location. In one aspect, the qualitative data may include information about, or links related to, resources or services that may help the prospective mover further explore the location.

In one aspect, the system includes a mechanism that displays the range of values for the quantitative data attributes for each location or for all the locations collectively.

In one aspect, the system includes a mechanism allowing prospective movers to establish desirable limits on attributes of their choosing.

In one aspect, the system includes a mechanism combining the prospective mover's chosen attributes to establish a ranked list of all the locations, the ranking of which depicts those locations that best satisfy the needs and interests of the prospective mover.

In one aspect, the system includes a mechanism to present the attribute values in an absolute fashion. In one aspect, the system includes a mechanism to present the attribute values in a relative fashion compared to the typical or average values.

In one aspect, the system includes a mechanism to isolate and display single attributes even when several attributes are selected as important. In one aspect, the isolated attributes may be independently and dynamically modified by the prospective mover.

In one aspect, the system includes a mechanism to amplify the weighting of select attributes that are more important than others in the perception of the prospective mover. Through the Internet-based system, the reweighting of select attributes will alter the ranking of the various locations for the prospective mover.

In one aspect, the system includes a mechanism to allow the prospective mover to select and isolate favorite locations.

In one aspect, the system includes a mechanism to allow the prospective mover to isolate and display locations that completely meet the needs and interests of the prospective mover by virtue of those locations being within the limits of the prospective mover's selected attributes. In one aspect, the system includes a mechanism to allow the prospective mover to display locations that partially meet the needs and interests of the prospective mover on a ranked basis in accordance with how well each location meets the needs and interests of the prospective mover as identified with how far out of bounds each location's attributes are with respect to the limits established by the prospective mover. In one aspect, the system includes a mechanism to reference as “close matches” those locations that are within a specific range of being a complete match.

In one aspect, the system includes a mechanism to allow the prospective mover to create a profile that includes their ranked location list and favorite locations. In one aspect, the system includes a mechanism to allow the prospective mover to create multiple profiles, each possibly including different location ranks and different favorites based on different selections by the prospective mover.

In one aspect, the system includes a mechanism to allow the prospective mover to identify their current living location. In one aspect, the system includes a mechanism to score the current living location in accordance with how well said location meets the attributes and limits established by the prospective mover. In one aspect, the system includes a mechanism to rank the current living location as compared to all the other locations.

In one aspect, the system includes a mechanism to allow the prospective mover to share elements of their profile. In one aspect, the system includes a mechanism to allow the prospective mover to share elements of their profile on social media. In one aspect, the system includes a mechanism to allow the prospective mover to share elements of their profile via email. In one aspect, the system includes a mechanism to allow the prospective mover to share their favorite locations. In one aspect, the system includes a mechanism to allow the prospective mover to share their location ranks. In one aspect, the system includes a mechanism to allow the prospective mover to share their select attributes and limits.

In one aspect, the system includes a mechanism to allow the prospective mover to identify and select multiple reference locations. In one aspect, the system includes a mechanism to compare and correlate all attributes of the reference locations. In one aspect, the system displays the correlation between all the reference locations so that the prospective mover can identify common attributes. In one aspect, the system includes a mechanism allowing the prospective mover to select the correlated attributes most meaningful to the prospective mover. In one aspect, the system includes a mechanism that establishes limits for each of the selected correlated attributes based on the quantitative attribute values of all of the reference locations. In one aspect, the system includes a mechanism that displays all of the other locations that are within the automatically established limits of the selected correlated attributes. In one aspect, the system includes a mechanism that displays all of the “close match” locations in accordance with the description of “close match” mentioned earlier. In one aspect, the system includes a mechanism that displays all of the locations in rank order as established by how well they satisfy the automatically established limits of the selected correlated attributes.

### II. System Architecture Overview

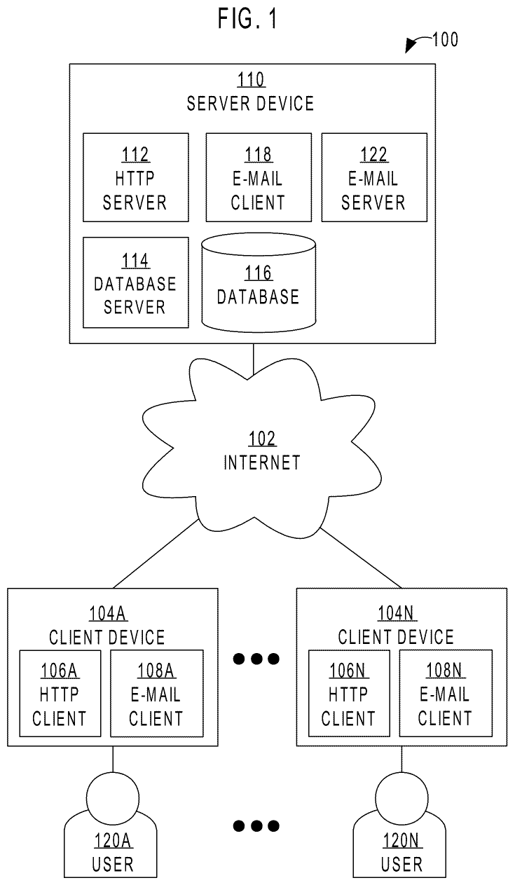

FIG. 1 is a block diagram that depicts a system for helping prospective movers interactively discover and explore ideal personalized living locations, in accordance with an implementation. System 100 includes the Internet 102, client devices 104A-N, and server device 110. Client devices 104A-N are coupled communicatively with Internet 102. Server device 110 also is coupled communicatively with Internet 102. Client devices 104A-N include Hypertext Transfer Protocol (HTTP) clients 106A-N, respectively, and e-mail clients 106A-N, respectively. Server device 110 includes HTTP server 112, database server 114, database 116, and e-mail client 118.

Users 120A-N are individual people who use client devices 104A-N, respectively, to send information to and receive information from server device 110. Client devices 104A-N are devices that are configured to interface with both a human being and Internet 102. For example, client devices 104A-N may include general-purpose computers, workstations, laptop computers, tablet computing devices, mobile devices including mobile phones, Internet appliances, etc.

HTTP clients 106A-N execute on the client devices 104A-N and are configured to send HTTP requests and receive HTTP responses. Example implementations of the HTTP clients 106A-N include, without limitation, Web browsers and application programs, also known as “apps.” HTTP clients 106A-N receive information from users 120A-N, respectively, and generate and send the information in the form of HTTP requests to HTTP server 112. HTTP clients 106A-N receive HTTP responses from HTTP server 112 and provide some or all of the information contained in such HTTP responses to users 120A-N, respectively. HTTP clients 106A-N send HTTP requests and receive HTTP responses through Internet 102. One example implementation is an application program executing on a mobile device, such as a mobile phone, that provides a graphical user interface for displaying information to users and receiving user inputs, and that also includes HTTP capability to communicate with the HTTP server 112. Although implementations are depicted in the figures and described herein in the context of HTTP, this is done for explanation purposes and implementations are not limited to the HTTP and are applicable to other protocols.

E-mail clients 108A-N are programs that are configured to send and receive e-mail messages according to any protocol. Example protocols include, without limitation, POP3, SMTP, and IMAP. For example, e-mail clients 108A-N may include Microsoft Outlook. E-mail clients 108A-N receive information from users 120A-N, respectively, and send that information in the form of e-mail messages to an e-mail server. E-mail clients 108A-N receive e-mail messages from e-mail servers and provide some or all of the information contained in such e-mail messages to users 120A-N, respectively. E-mail clients send and receive e-mail messages through Internet 102.

Like client devices 104A-N, server device 110 is a device that is configured to interface with Internet 102. For example, server device 110 may be a general-purpose computer. HTTP server 112 is a program that is configured to receive HTTP requests and send HTTP responses. HTTP server 112 is also called a “web server.” HTTP server 112 receives HTTP requests from HTTP clients 106A-N through Internet 102. HTTP server 112 sends HTTP responses to HTTP clients 106A-N through Internet 102.

HTTP server 112 may interface with a variety of programs that reside on server device 110. HTTP server 112 may send, to such programs, information received in HTTP requests. Similarly, HTTP server 112 may receive, from such programs, information that HTTP server 112 then sends in HTTP responses.

Database server 114 is a program that is configured to receive database commands from programs resident on server device 110. Database server 114 also is configured to execute such database commands to store data in, modify data in, or retrieve data from database 116. Database server 114 also is configured to send retrieved data to programs resident on server device 110. For example, database commands may take the form of Structured Query Language (SQL) statements. Database server 114 may select, from database 116, data that satisfies criteria specified in such SQL statements.

E-mail client 118 is similar to e-mail clients 108A-N in that e-mail client 118 also is a program that are configured to send and receive e-mail messages according to an e-mail protocol. E-mail client 118 receives information from programs resident on server device 110, and sends that information in the form of e-mail messages to an e-mail server. E-mail client 118 receives e-mail messages from an e-mail server and provides some or all of the information contained in such e-mail messages to programs resident on server device 110.

Database 116 stores information about user accounts. Each of users 120A-N may be associated with one or more user accounts. Among other information, each account may be associated with a separate username and password. For each account, database 116 stores a separate set of information items that are associated with that account. The set of information items associated with a particular account may vary depending on the account's account type.

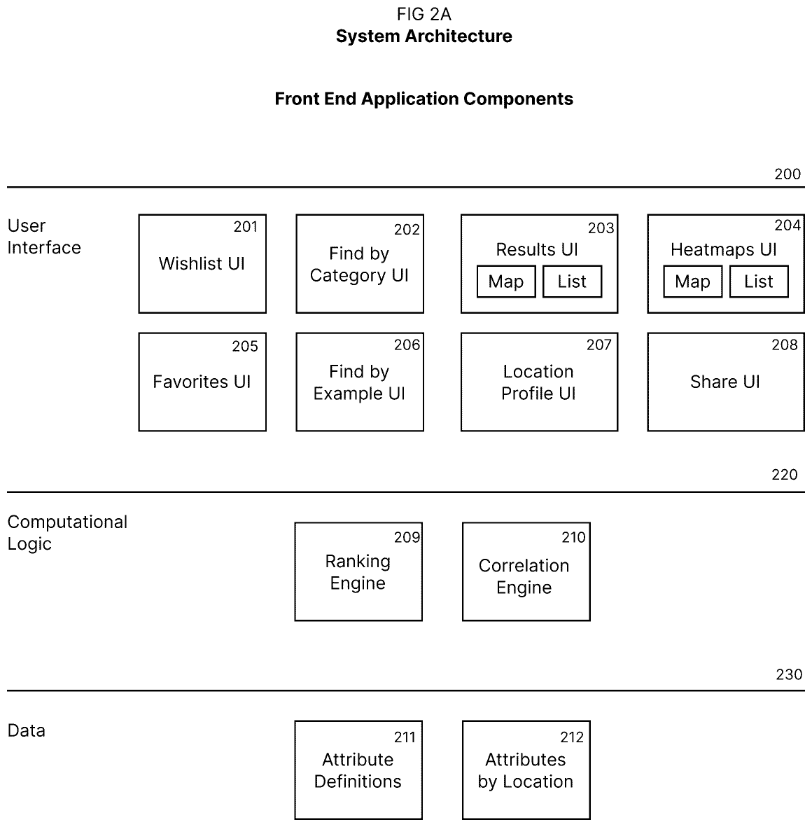

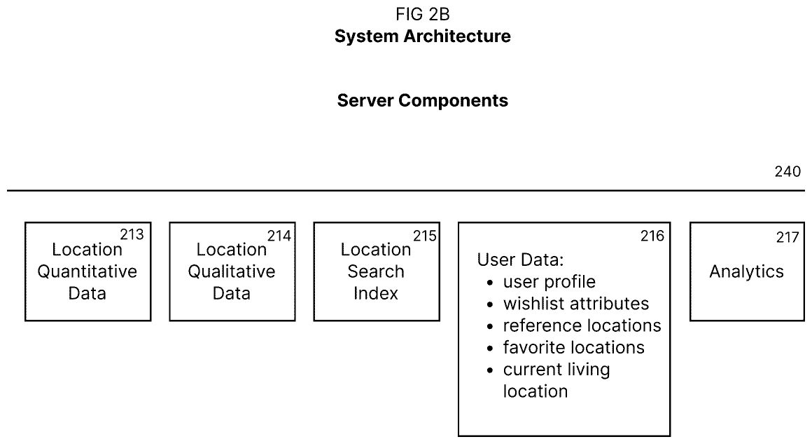

FIG. 2A is a block diagram that depicts a set of system architecture front-end application components, in accordance with an implementation.

User Interface (UI) 200 includes the Wishlist UI 201, Find by Category UI 202, Results UI 203, Heatmaps UI 204, Favorites UI 205, Find by Example UI 206, Place Profile UI 207, and Share UI 208.

Computation Logic 220 includes the Ranking Engine 209, and Correlation Engine 210.

Data 230 includes the Attribute Definitions 211, and Attributes by Place 212.

FIG. 2B is a block diagram that depicts a set of system architecture server components, in accordance with an implementation.

Server Components 240 includes the Places Quantitative Data 213, Places Qualitative Data 214, Places Search Index 215, User Data 216, and Analytics 217.

User Data 216 includes the User Profile, the Wishlist, the Reference Locations, the Favorites Locations, and the Current Living Location. User Data 216 may be associated with a username that is unique among usernames stored in database 116. User Data 216 may be associated with a set of information items including user profile, wishlist attributes, reference locations, favorite locations, and current living location.

Different user accounts may be associated with separate sets of such information items. For example, a first user account may be associated with a first set of wishlist attributes, and a second, separate user account may be associated with a second, separate set of wishlist attributes.

Information items described above may be used in interactions between components of system 100. Examples of such components using these information items are described in further detail below.

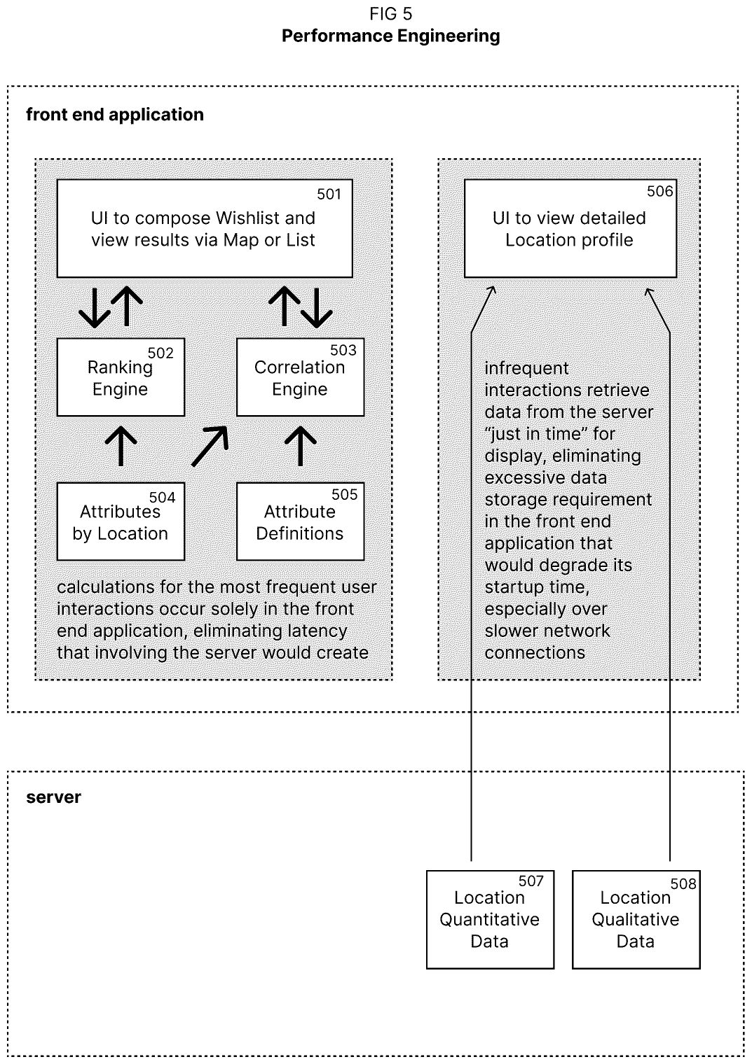

FIG. 5 is a flow diagram that depicts an approach for enhancing system performance and reducing latency that could impact the user's experience, in accordance with an implementation. Calculations for the most frequent user interactions such as the wishlist, map, or lists 501, ranking engine 502, correlation engine 503, attributes by location 504, or attribute definitions 505, occur solely in the front-end application, eliminating latency that involving the server would create. Infrequent interactions, such as the UI to view detailed location profiles 506, retrieve data from the server “just in time” for display, eliminating excessive data storage requirements in the front-end application that would degrade its startup time, especially over slower network connections. The UI to view detailed location profiles 506 if comprised of Location Quantitative Data 507 and Location Qualitative Data 508, both of which are stored on the server.

### III. Personalization by Location Attributes

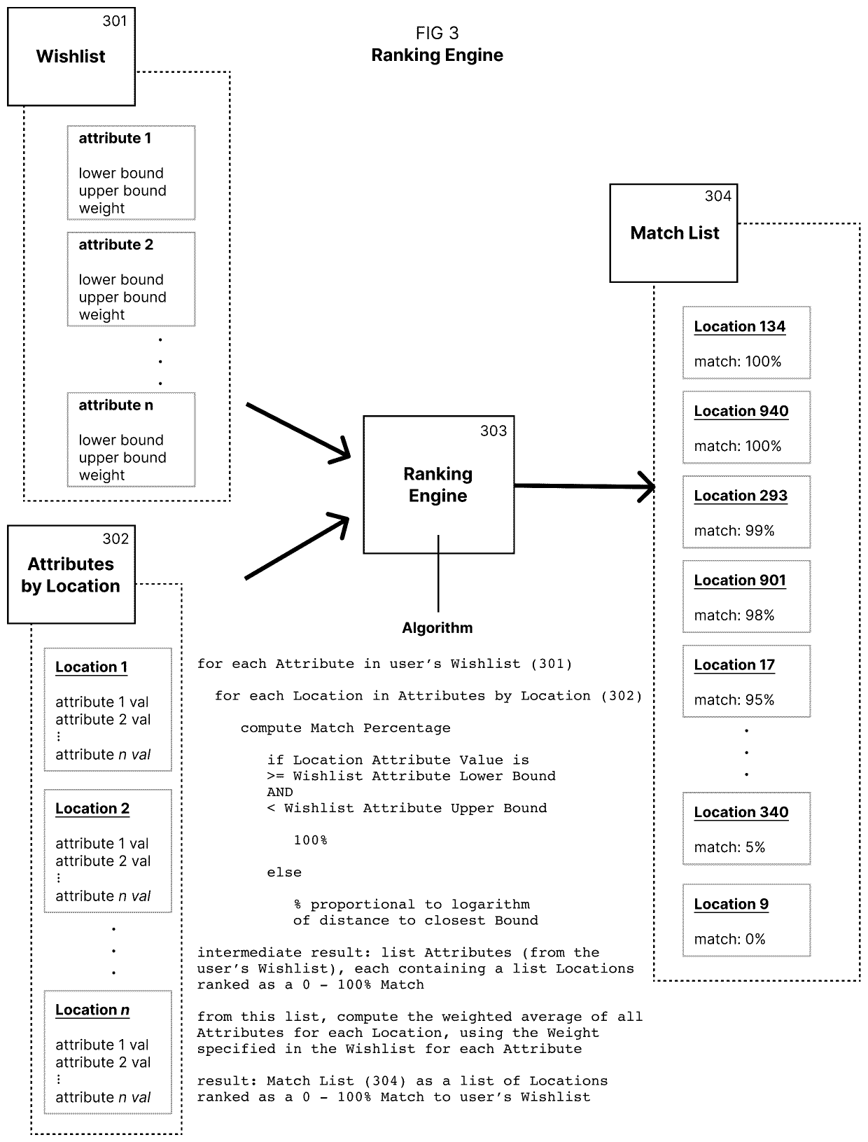

FIG. 3 is a flow diagram that depicts an approach for ranking locations based on user selection of important location attributes 301, in accordance with an implementation.

The Wishlist 301 is comprised of various location attributes grouped into various categories, which may include the following, though the following list is not exhaustive:
Activities: boating, cycling, fishing, golf, hiking, hunting, national parks, rock & mountain climbing, skiing
Arts & Entertainment: art museums, history museums, live music, performing arts, regional theater
Crime: gang presence, homicide rate, property crime rate, violent crime rate
Demographics: median age, ethnicity/race (american indians/alaskan natives, asian americans, blacks/african americans, hispanics/latinos, multiracial s, native hawaiians/pacific islanders, whites), households (same sex households, single parent households), language spoken at home (asian language speakers, english speakers, indo-european language speakers, other language speakers, spanish speakers), population by age (people 0-9 years old, people 10-19 years old, people 20-29 years old, people 30-39 years old, people 40-49 years old, people 50-59 years old, people 60-69 years old, people 70-79 years old, people 80+ years old)
Dining: alcohol (craft breweries, wineries), cuisine diversity, farmers markets, michelin rated restaurants
Economics: median income, affordability (income/expenses), typical expenses, homelessness, poverty rate, public assistance, unemployment rate, financial relocation incentives, other relocation incentives
Education: ACT/SAT scores, educational attainment, high school graduation rate, school rating
Environment: air quality, water quality
Friends & Family: drive time to locations, flight time to locations
Geography & Nature: elevation, forests, freshwater access, mountains, scenic beauty, seacoast proximity
Grab Bag (Miscellaneous): broadband internet, happiness, meth labs, nuclear strike risk
Health & Medical: healthcare services (primary care physicians, mental health providers, dentists, hospitals), lifestyle (life expectancy, obesity rate, smokers) Housing: buying (median home price, home ownership rate, investment potential), renting (median rental price, cat friendly rentals, dog friendly rentals)
Natural Disasters: any natural disaster, avalanche, coastal flooding, cold wave, drought, earthquakes, hail, heat wave, hurricanes, ice storms, landslide, lightning, river flooding, strong wind, tornadoes, tsunami, volcanic activity, wildfires, winter weather
Pests & Wildlife: fire ants, mosquitos, shark attacks, termite infestation, venomous snakes
Politics: political orientation
Population: major city proximity, city population, county population, population density, population growth
Religion: buddhists, catholics, hindus, jehovah's witnesses, jews, lds/mormons, muslims, not religious/atheists/agnostics, orthodox christians, other christians (e.g., amish, mennonite), protestants/non-denominationals
Rights & Freedoms: abortion regulation, alcohol regulation, cannabis regulation, gun regulation, private/home school regulation, tobacco regulation
Sports: major league baseball, major league soccer, minor league baseball, nba basketball, nfl football, nhl hockey, ncaa baseball, ncaa basketball, ncaa football, ncaa hockey, ncaa soccer
Taxes: property tax rate, sales tax rate, state income tax rate
Transportation: airport proximity (major airport, small or major airport, any airport), automobiles (commute time, electric vehicle chargers, gasoline prices, traffic), other transportation (bike commuters, mass transit, walkability)
Weather: precipitation (rain, snow, sunny days), temperature (seasons, summer heat, summer mugginess, winter cold), other (windiness)

Some wishlist attributes may be variable, dependent on the user's family size and number of income earners. The UI will make provision to collect this information from the user, in accordance with an implementation.

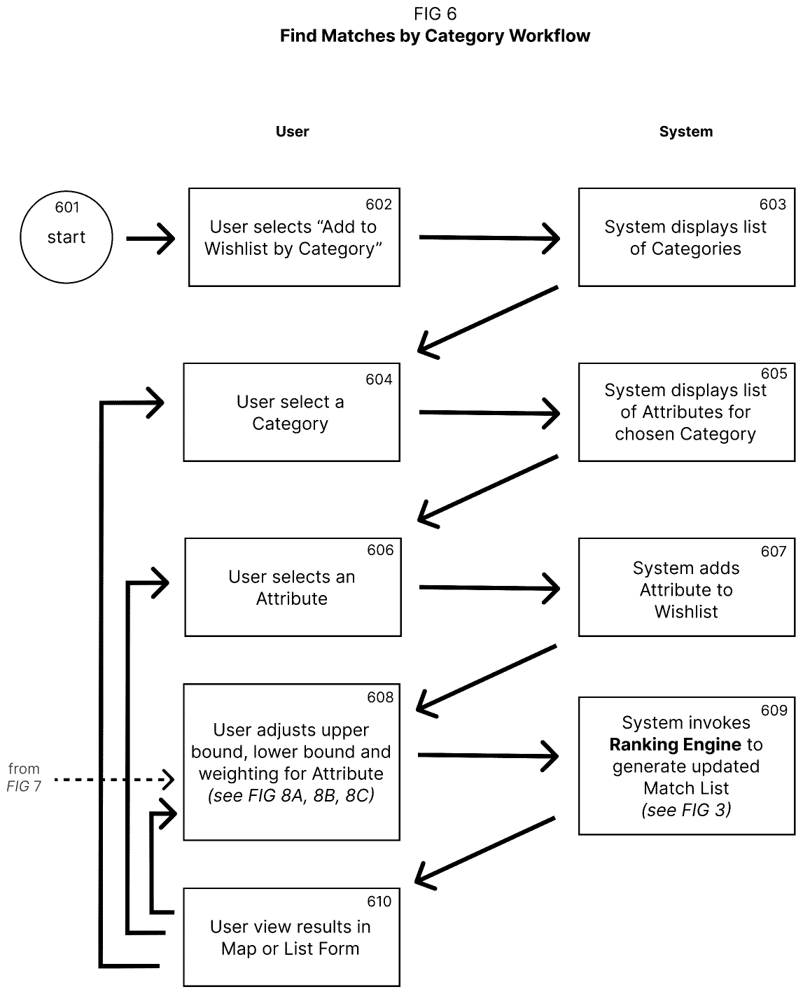

FIG. 6 is a flow diagram that depicts a workflow approach for Finding Matches by selecting Category Attributes, in accordance with an implementation.

In block 602, user takes an action signifying interest in adding a location attribute to their wishlist 301.

In block 603, system displays a list of categories from which the user can select. As described earlier, the categories may include topics such as crime, politics, and weather.

In block 604, user selects a single category, which prompts the system to display the list of attributes for the selected category 605. The user may only select one category at a time, but may later select additional categories, again, one at a time.

In block 606, user selects a single location attribute to be added to user's Wishlist 301. User may then select and add additional location attributes to be added to the user's Wishlist 301.

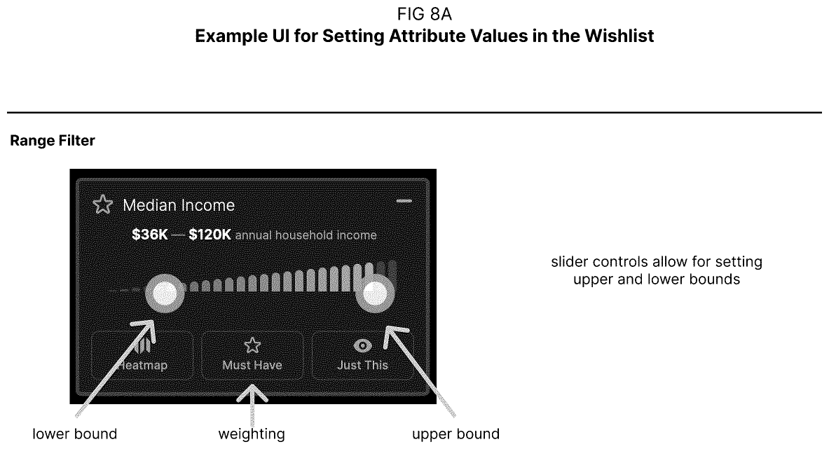

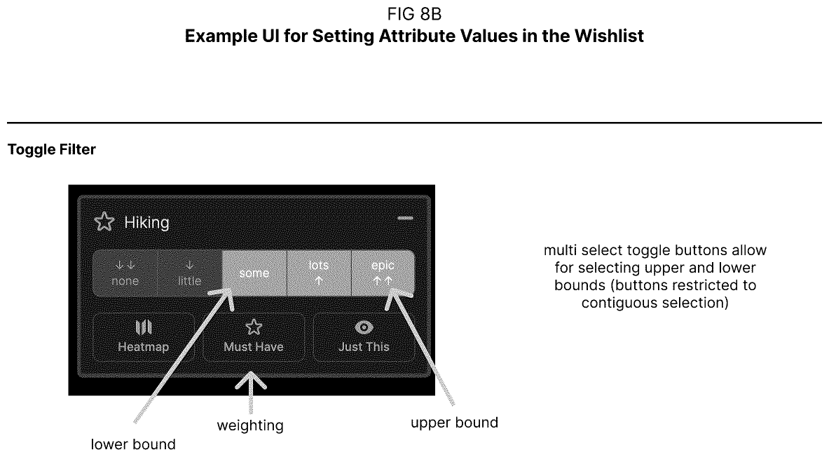

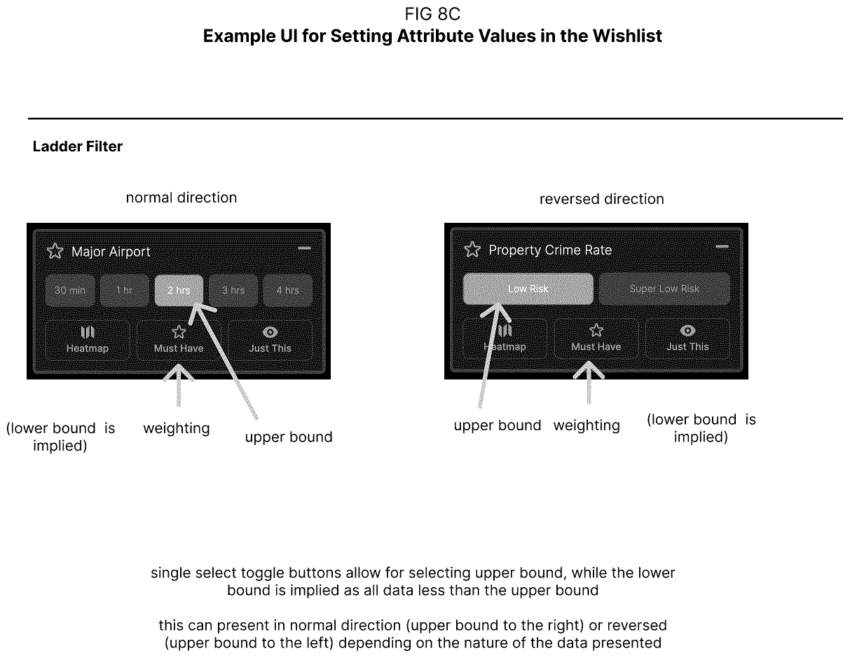

In block 608, user may adjust an upper bound, lower bound, or weighting (see FIGS. 8A, 8B, and 8C) for each location attribute in the Wishlist 301.

In block 609, system invokes the Ranking Engine (see FIG. 3) to generate or update the Location Match List 304.

In block 610, system displays the Match List 304 in map or list form.

User may continue to add 604 or remove categories, add 606 or remove attributes, or adjust attribute bounds and weightings until they are satisfied.

IV. Allowing Users to Establish Limits on their Desired Attributes

The wishlist attributes in block 301 may include a user-established upper bound, a user-established lower bound, and a user-established preference weight, in accordance with an implementation.

The Attributes by Location 302 is comprised of various locations, each containing the wishlist attributes unique to each location, in accordance with an implementation.

FIG. 8A is an example depiction of a slider control method to set attribute values for wishlist attributes, in accordance with an implementation. By moving the slider buttons, the user dynamically changes the desired upper and lower bounds of the wishlist attributes 301.

FIG. 8B is an example depiction of a toggle filter control method to set attribute values for wishlist attributes, in accordance with an implementation. By selecting toggle buttons, the user dynamically establishes the desired upper and lower bounds of the wishlist attributes 301. In the case of the toggle button filter, the buttons will only allow contiguous button selection so that there is only a single upper and lower bound.

FIG. 8C is an example depiction of a ladder control method to set attribute values for wishlist attributes, in accordance with an implementation. By selecting toggle buttons, the user dynamically establishes a desired upper or lower bounds, but not both, of the wishlist attributes 301. The context of the attribute serves to determine whether or not an upper bound or lower bound is established. For a desirable attribute such as a short distance to the airport, the toggle creates an upper bound. Similarly, for an undesirable property, such as violent crime, the toggle again creates an upper bound, since a lower value is universally more desirable than a larger.

### V. Comparing Attribute Values Against a Typical Norm

For several of the attributes, users will have some innate sense of what a desirable limit may be. For example, most people will be able to select the amount of snow they are willing to accept in an ideal living location. However, for many attributes, users have no such sense. For example, how much violent crime is acceptable, or how many hiking trails are desirable?

To address this understandable human limitation, some toggle filters (see FIG. 8B) present attribute controls in terms of what is typical or normal across all locations as compared to locations that possess less than normal, much less than normal, more than normal, or much more than normal levels of the selected attribute.

### VI. Allowing Users to Combine Attributes, Resulting in a Ranked List of Locations

The Ranking Engine 303 implements an algorithm that uses the information from Wishlist 301 and Attributes by Location 302 to compute a Match List 304, in accordance with an implementation.

The Ranking Engine 303 algorithm may operate in the following fashion, in accordance with an implementation. For each attribute activated in user's Wishlist 301, compute a match percentage for each location in Attributes by Location 302. If the Location attribute value is greater than or equal to the Wishlist attribute lower bound and if the location attribute value is less than or equal to the Wishlist attribute upper bound, the match percentage is 100%. Otherwise, the match percentage is proportional to the logarithm of the distance to the nearest bound.

### VII. Increased Weighting of User-Selected Critically Important Attributes

The Ranking Engine 303 algorithm can then create a weighted average Match List 304 by incorporating the user-established preference weight found in Wishlist 301, in accordance with an implementation.

Match List 304 may include each location, ranked and sorted per the algorithm of the Ranking Engine 303, in accordance with an implementation.

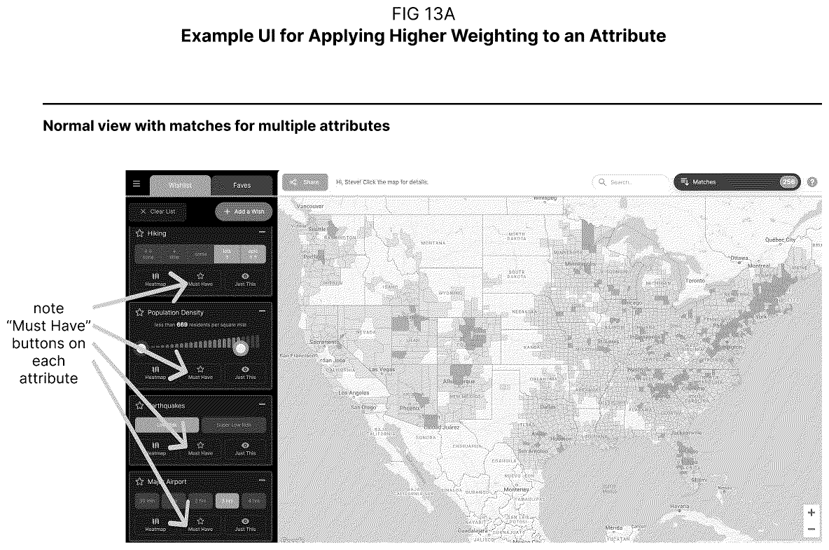

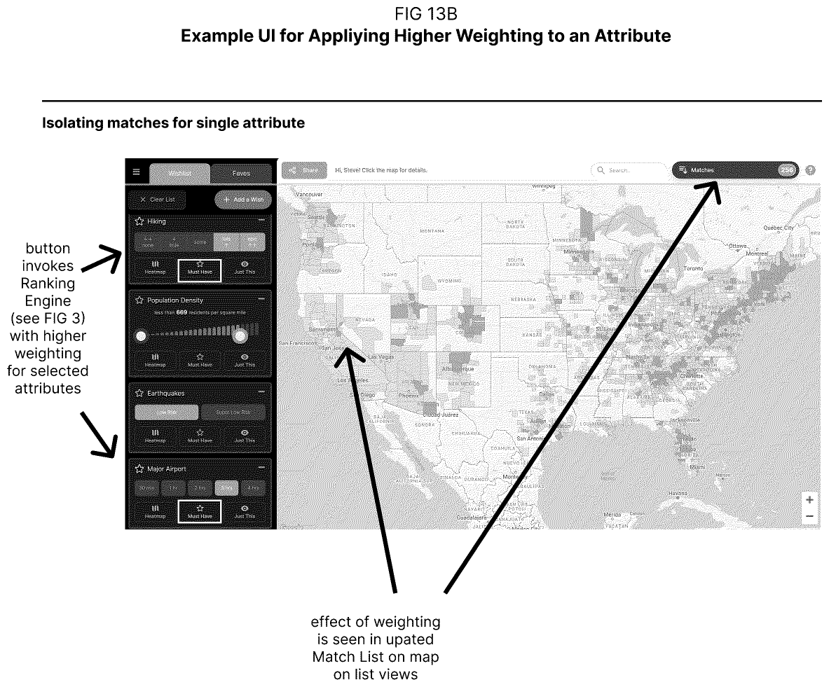

FIGS. 13A and 13B are an example depictions of a method to increase the user-selected weighting for select attributes, in accordance with an implementation. By selecting the “Must Have” button(s), the user dynamically changes the Match List 304 as depicted in FIGS. 13A and 13B. Although implementations are depicted in the figures and described herein in the context of a user specifying an increased weighting by selecting the “Must Have” control on the graphical user interface, implementations are not limited to specifying a single weighting via a control option and may include options for selecting from multiple weightings. For example, according to an implementation, a slider control is provided that allows a user to specify a weighting along a scale between 0 and 100%, where 50% represents a normal weighting, 0% represents a minimal weighting, and 100% represents a maximum weighting. In addition, attributes of the slider control and scale, such as color, may change as the user moves the slider control to provide a visual indication of the corresponding weighting. For example, as the user moves the slider control towards 100%, the scale and indicated weighting change color to green and when the slider control reaches 100%, a “Must Have” icon is displayed. Similarly, as the user moves the slider control towards 0%, the scale and indicated weighting change color to yellow and when the slider control reaches 0%, a “Less Important” icon is displayed. According to an implementation, a sound is generated when the slider reaches 0% or 100% on the scale to audibly notify the user that an endpoint on the scale has been reached.

### VIII. Allowing Users to Use Desirable Reference Locations to Discover More Locations Sharing the Same Attributes

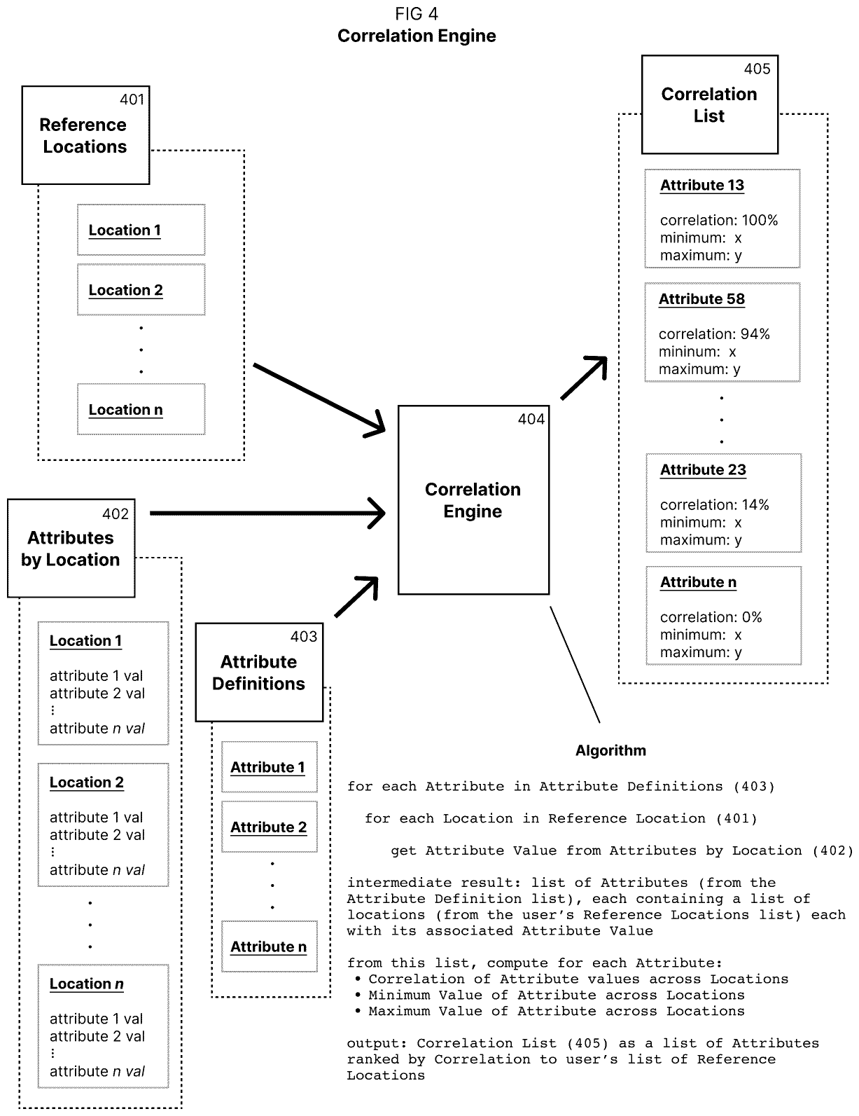

FIG. 4 is a flow diagram that depicts an approach for creating a sorted and ranked Correlation List 405, based on the user-established Reference Locations 410, in accordance with an implementation.

Reference Locations 401 is comprised of various user-selected locations representing places user likes and would like to find locations possessing similar location attributes, in accordance with an implementation.

The Attributes by Location 402 is comprised of various locations, each containing the wishlist attributes unique to each location, in accordance with an implementation.

The Attribute Definitions 403 is comprised of a list of the locations from Reference Locations 401, each location conveying its associated attributes and their values 402. From this list, for each attribute, the following values are computed: minimum attribute value, maximum attribute value, and attribute value correlation across locations, in accordance with an implementation.

Correlation List 404 may include each attribute, ranked and sorted per the algorithm of the Correlation Engine 404, in accordance with an implementation. The Correlation Engine 404 uniquely determines matches with high relevancy by considering locations that a user has expressed an interest in.

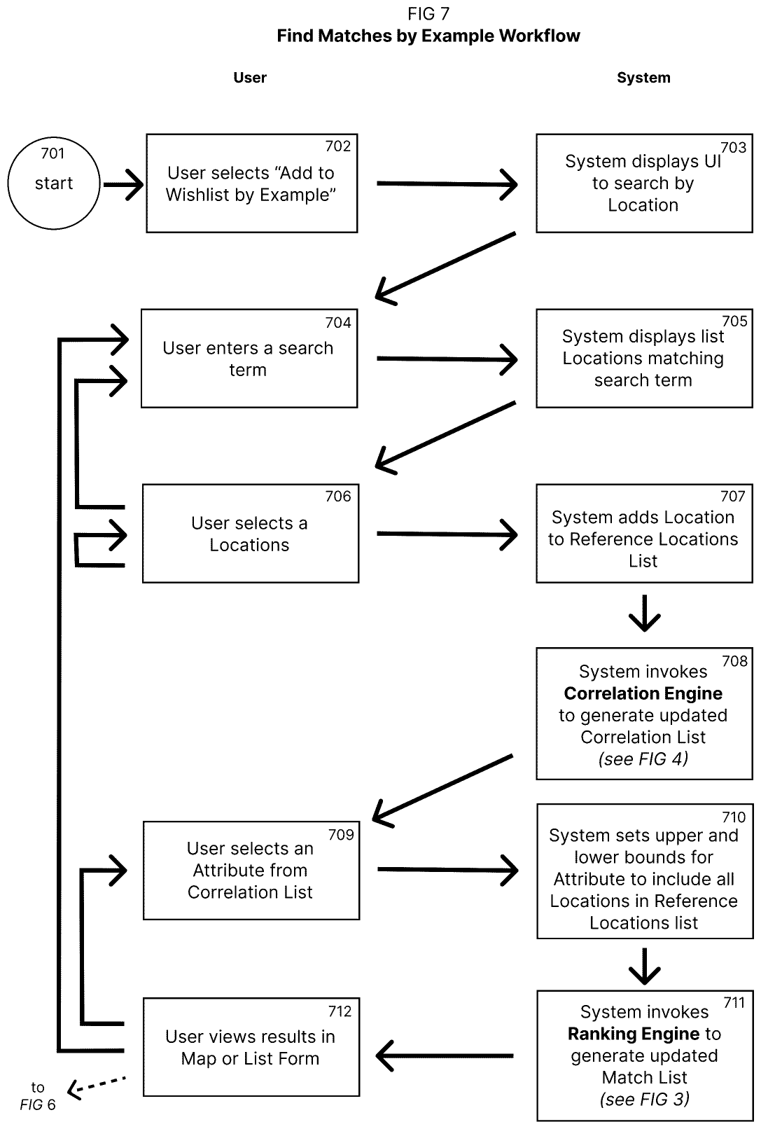

FIG. 7 is a flow diagram that depicts a workflow approach for Finding Matches by Example locations, in accordance with an implementation.

In block 702, user takes an action signifying interest in adding to their wishlist by use of example locations.

In block 703, system displays a UI to search for locations.

In block 704, user enters a location search term, which prompts the system to display a list of locations matching the entered search term 705. The user may only select one location at a time, but may later select additional locations, again, one at a time. The system adds each of the selected locations to the Reference Locations List 707.

In block 708, system invokes the Correlation Engine (see FIG. 4) to generate or update the Correlation List 405.

In block 709, user selects and activates what they perceive to be important attributes from the Correlation List 405.

In block 710, system establishes upper and lower bounds for the activated attributes for all locations in the Reference Locations list 401.

In block 711, system invokes the Ranking Engine 303 to generate or update the Match List 304.

In block 712, user views results in map or list form 203

### IX. Ranking and Displaying Close Matches

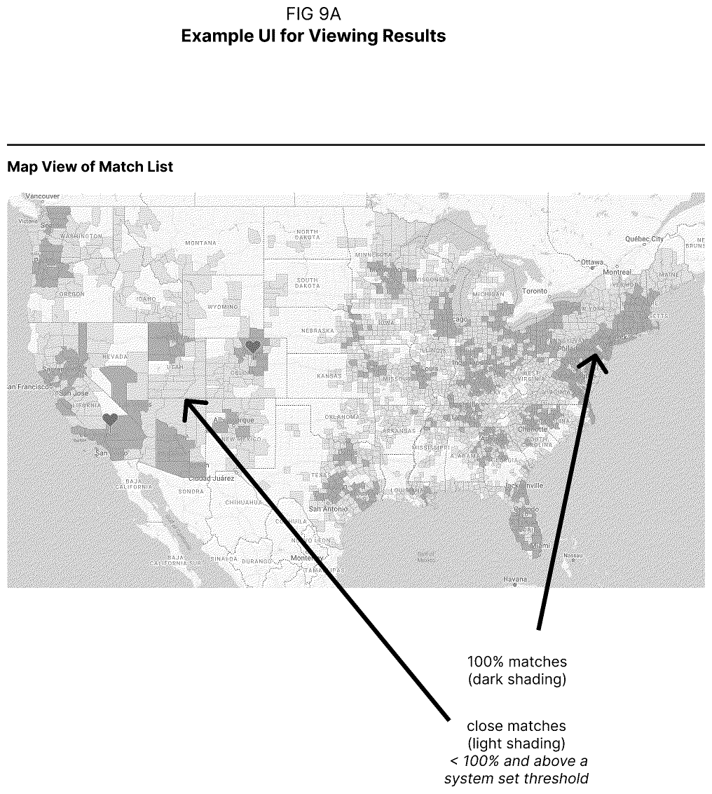

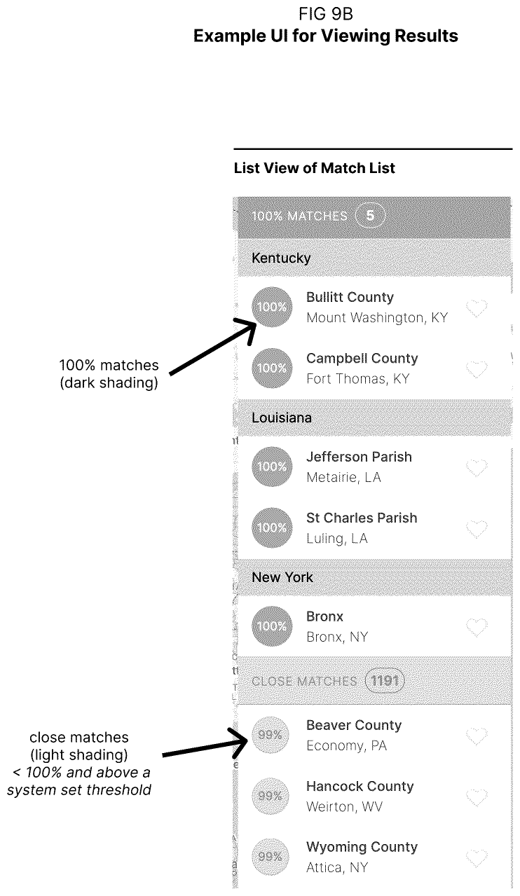

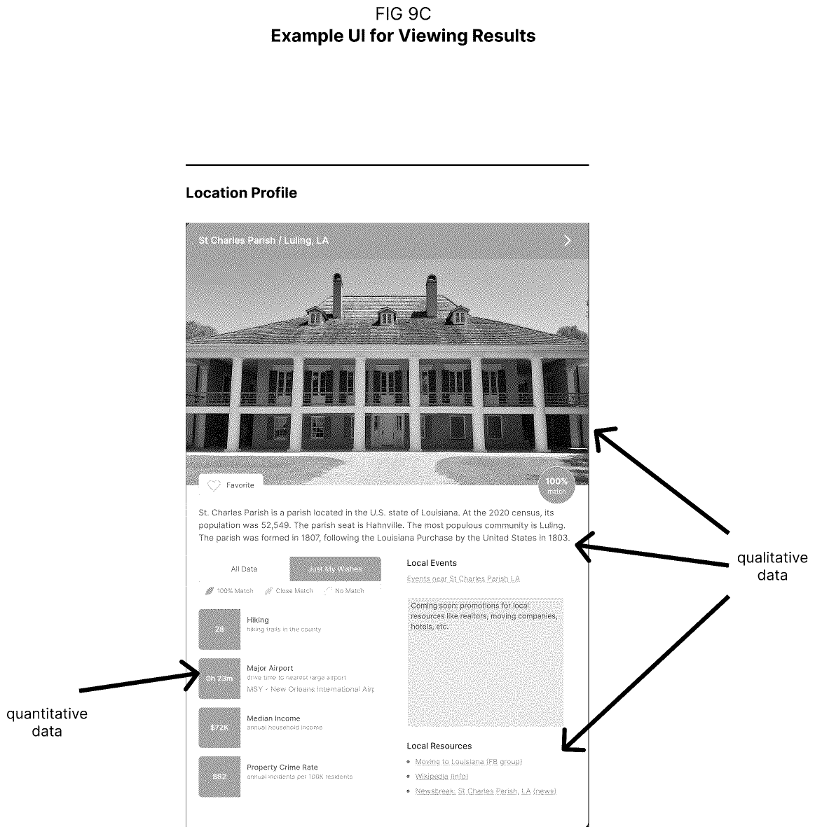

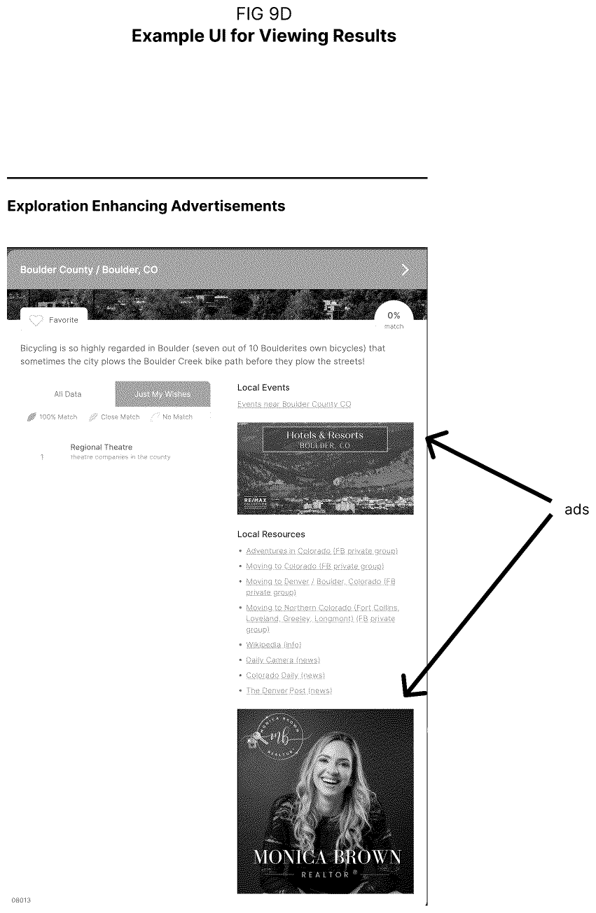

FIG. 9A is an example depiction of a map showing the difference between locations that are 100% (darker shading) on the match list 301, and those that are less than 100% (lighter shading), in accordance with an implementation. In one aspect, the shading corresponds to the level of location match quality. In one aspect, the “close matches” may have a system-established limit, below which the location will have no shading at all.

FIG. 9B is an example depiction of a list showing the difference between locations that are 100% (darker shading) on the match list 301, and those that are less than 100% (lighter shading), in accordance with an implementation. In one aspect, the shading corresponds to the level of location match quality. In one aspect, the “close matches” may have a system-established limit, below which the location will have no shading.

### X. Categorizing the Qualitative and Quantitative Measures as Descriptors for Locations

FIG. 9C is an example depiction of a Location Profile 207 containing both Quantitative Data 213 and Qualitative Data 214, in accordance with an implementation. Quantitative Data may be comprised of the Attributes by Location 302. In one aspect, the qualitative data may include images depicting the location. In one aspect, the qualitative data may include hyperlinks to local news and information sources for each location. In one aspect, the qualitative data may include notable facts about the location or notable people associated with the location. In one aspect, the qualitative data may include information about or links related to events occurring in the location. In one aspect, the qualitative data may include information about or links related to resources or services that may help the prospective mover further explore the location, such as social media groups with similar interests.

### XI. Monetizing Via Exploration Enhancing Advertisements

FIG. 9D is an example depiction of a Location Profile 207 containing both Quantitative Data 213 and Qualitative Data 214, in accordance with an implementation. In one aspect, the qualitative data may include informative advertisements that support the user's ability to explore or relocate to the location, in accordance with an implementation. In one aspect, the advertisements can represent location local realtors. In one aspect, the advertisements can represent location local hotels. In one aspect, the advertisements can represent location local destinations. In one aspect, the advertisements can represent location-supporting movers. In one aspect, the advertisements can represent location local restaurants. In one aspect, the advertisements can represent location-supporting mortgage brokers. In one aspect, the advertisements can represent location local rental managers. In one aspect, the advertisements can represent location-supporting travel agents or airlines. In one aspect, the advertisements can represent location local hiring employers.

### XII. Comparatively Displaying the Value Ranges for the Various Attributes Via Heatmaps

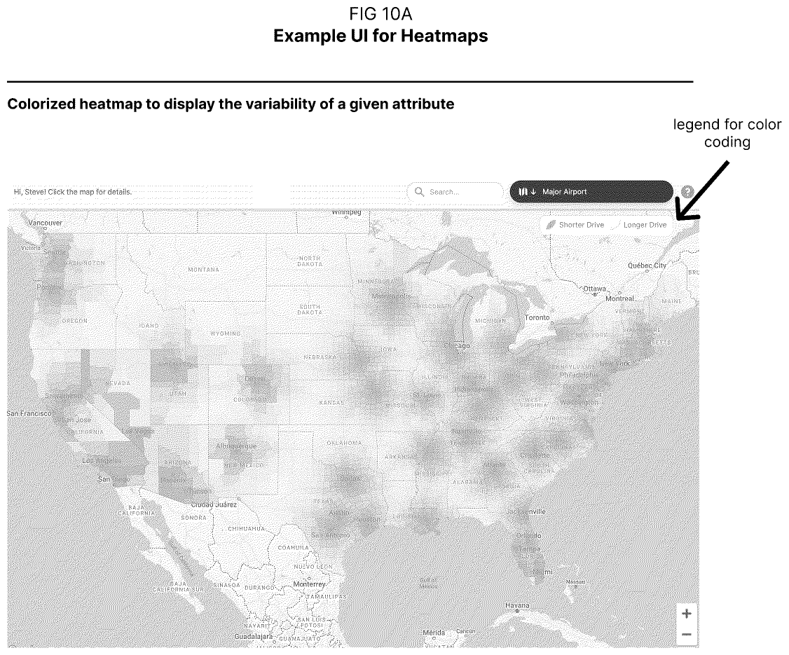

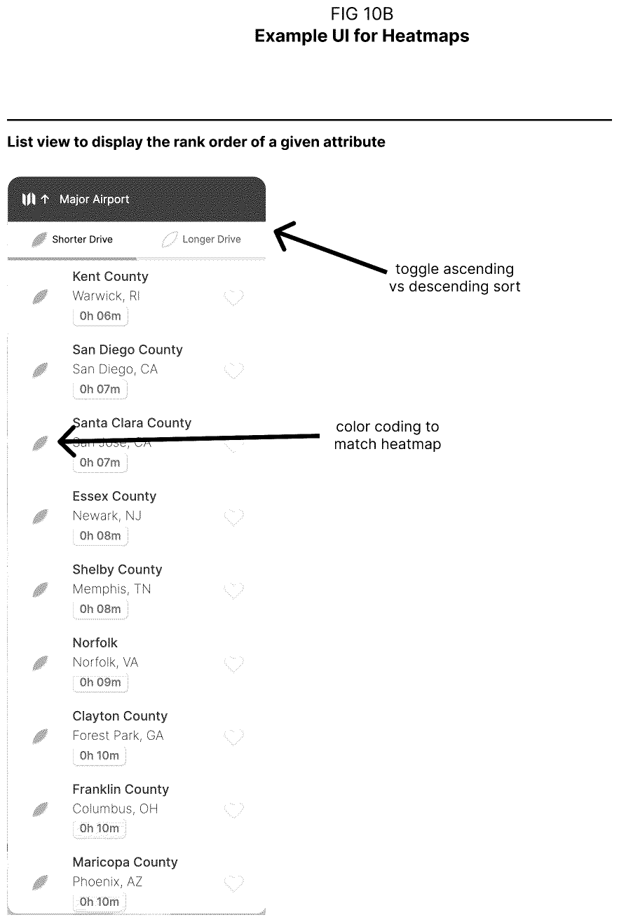

FIG. 10A is an example depiction of a map showing the variability of a select location attribute across all locations, in accordance with an implementation. In one aspect, the shading is monochromatic and shaded corresponding to the location quantitative data 213 for each location. In one aspect, the shading is polychromatic, the color transitions corresponding to the location quantitative data 213 for each location.

FIG. 10B is an example depiction of a list showing the variability of a select location attribute across all locations, in accordance with an implementation. In one aspect, the shading is monochromatic and shaded corresponding to the location quantitative data 213 for each location. In one aspect, the shading is polychromatic, the color transitions corresponding to the location quantitative data 213 for each location. In one aspect, the list may be ordered by the value of the location attribute. In one aspect, the list may be reverse ordered by the value of the location attribute.

### XIII. Allowing Users to Select Favorites

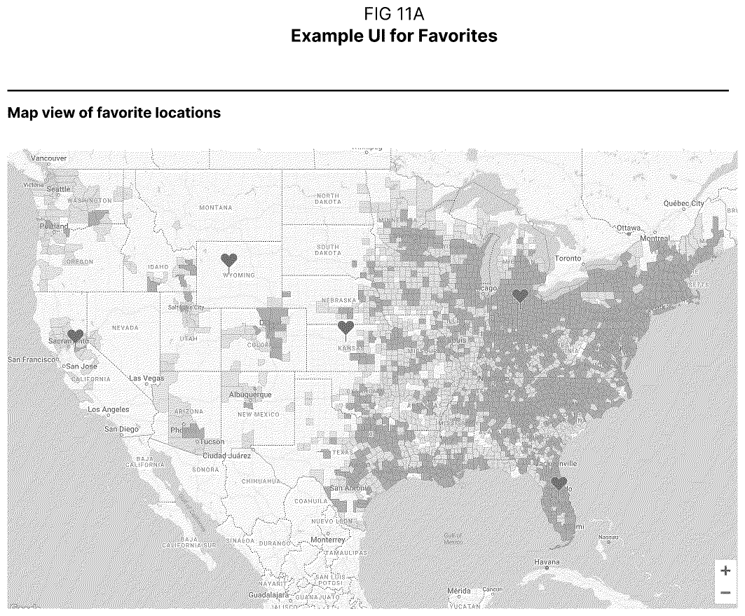

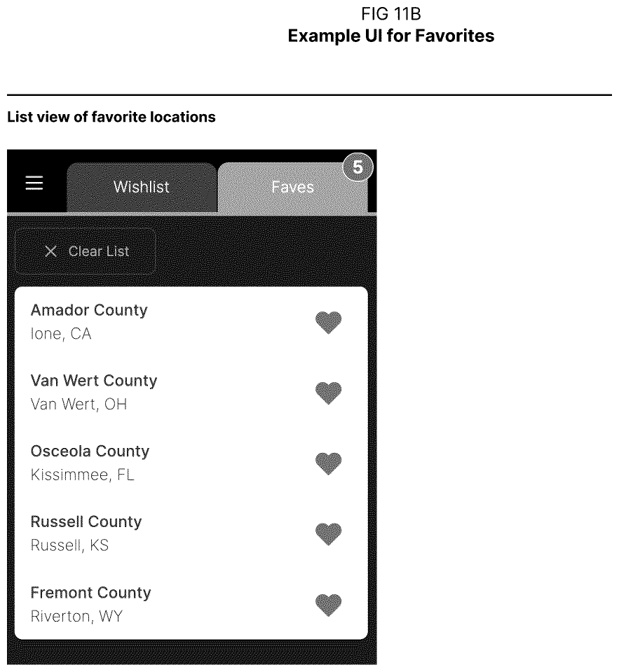

FIG. 11A is an example depiction of a map showing the user-selected favorite locations against the backdrop of all locations, in accordance with an implementation. In one aspect, the favorite locations are identified by a superimposed icon on the map. In one aspect, the favorite locations are identified by a bold or colored outline for the select locations. In one aspect, the favorite locations are identified by a differentiated color for the select locations. In one aspect, the location may be selected or deselected as a favorite on the match list (see FIG. 9B) or the location profile (see FIG. 9C).

FIG. 11B is an example depiction of a list showing the user-selected favorite locations, in accordance with an implementation. In one aspect, the location may be deselected as a favorite on the favorite list.

### XIV. Isolating Attributes to Allow Dynamic Selection of Limits

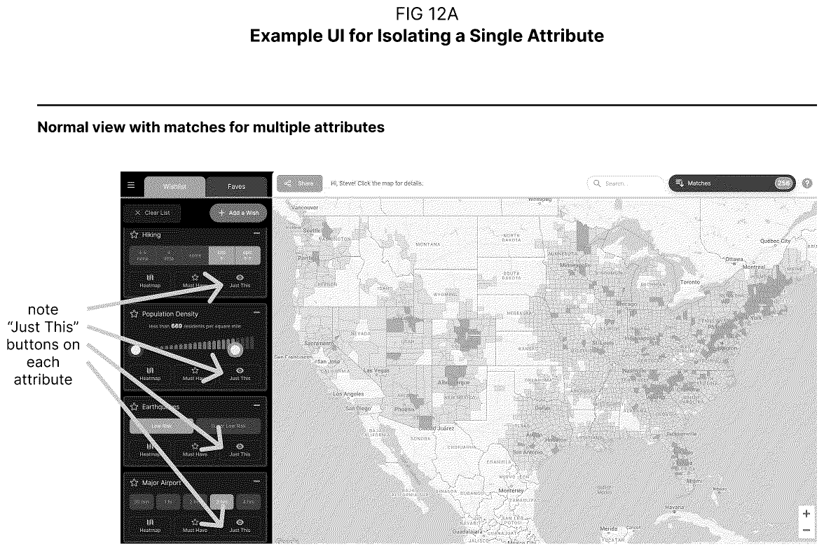

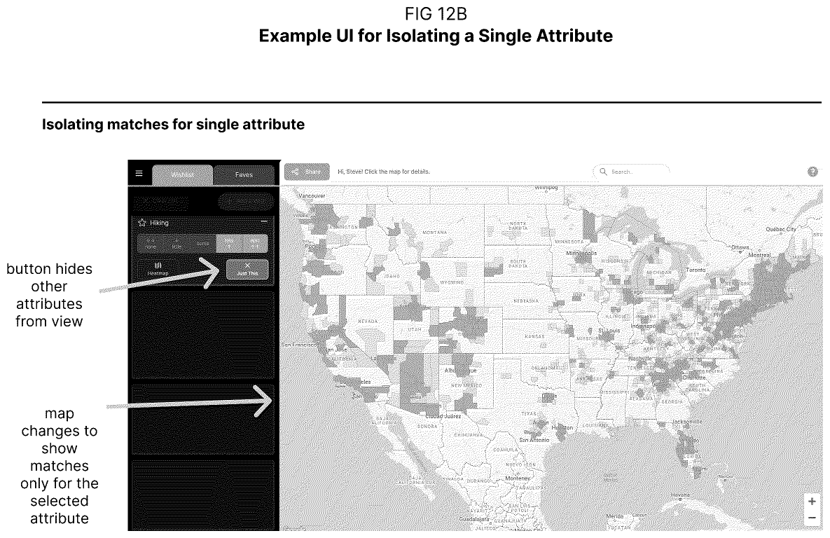

FIG. 12A is an example depiction of a map showing how a select wishlist attribute can be isolated, temporarily ignoring all other wishlist attributes, in accordance with an implementation. As the users activates more and more attributes onto the wishlist 301, it gets more difficult to distinguish the impact of any single attribute and its limits on the match list 304. To remedy this problem, the user may toggle the “Just This” button.

FIG. 12B is an example depiction of a map demonstrating what would happen when the “Just This” button is activated. In one aspect, when the “Just This” button is activated, the other activated attributes are temporarily deactivated. In one aspect, when the “Just This” button is activated, the other activated attribute are temporarily grayed out or hidden from the user. In one aspect, when the “Just This” button is activated, the map is temporarily recolored as if only the “Just This” attribute was activated. In one aspect, when the “Just This” button is activated, the attribute controls allow the user to observe the impact of changing the attribute settings as if only the “Just This” selected attribute is active.

XV. Allowing Users to Create Profiles, Including their Ranked Location Lists and Favorites

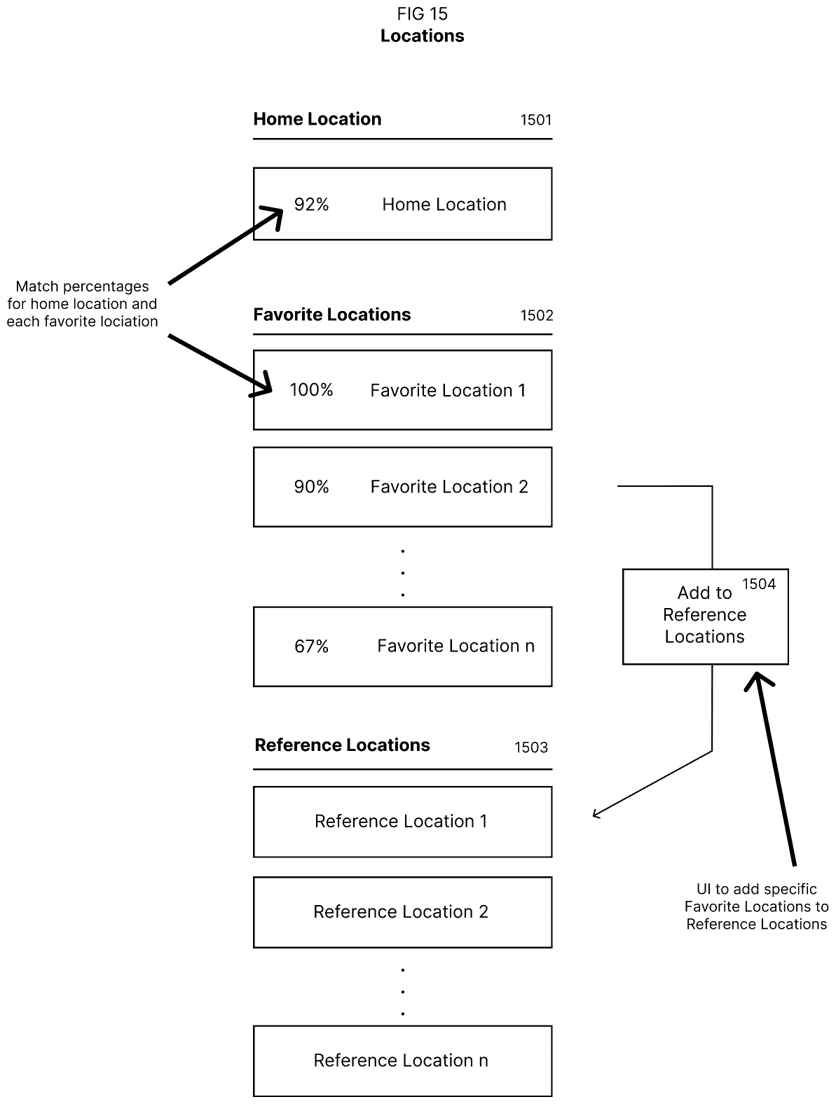

FIG. 15 is an example of a UI presenting three different location categories related to the user, in accordance with an embodiment of this invention. The first category is Home Location 1501, which represents the user's current living location or primary residence. The second category is Favorite Locations 1502, which represents the locations the user is interested in exploring as a possible future move location. The third category is Reference Locations 1503, which represents locations the user likes and would like to find locations with similar attributes for a possible future move location. In one aspect, the locations are listed with their match list 304 percentage score. In one aspect, the locations are listed with their match rank, relative to all the locations. In one aspect, locations in one category may be automatically also included in a different category. In one aspect, locations in one category may also be manually included in a different category.

XVI. Allow Users to “Score” and Rank their Current Living Location for Use as a Reference

The user's home or current living location may be distinctly visible in the UI as an indicator of how satisfied they are living there, in accordance with an embodiment of this invention. In one aspect, the home location will be accompanied by the location's match list 304 percentage score to show the user how well their home location satisfies their ideal. In one aspect, the home location will be accompanied by the location's match rank relative to all the locations. The match rank will indicate to the user the number of other locations that are perhaps more ideal than their current home location.

XVII. Allowing Users to Share their Profiles 14A/14B/14C

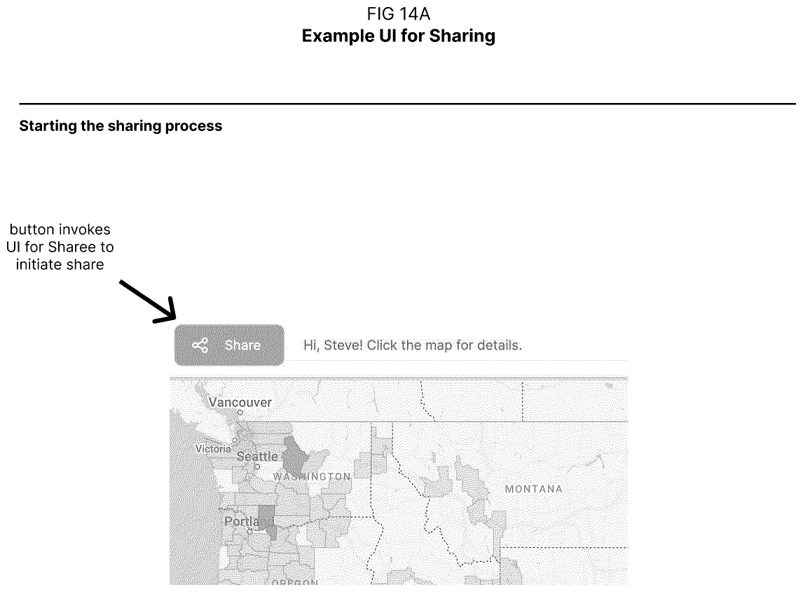

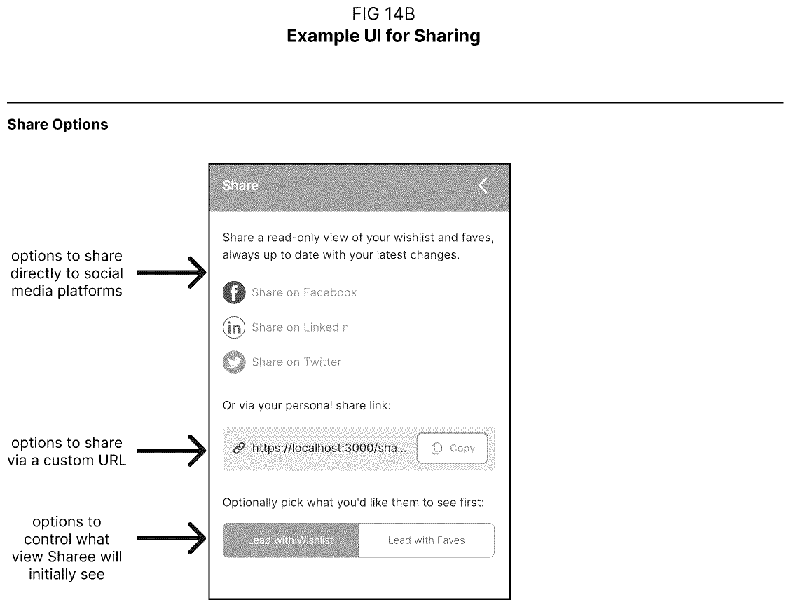

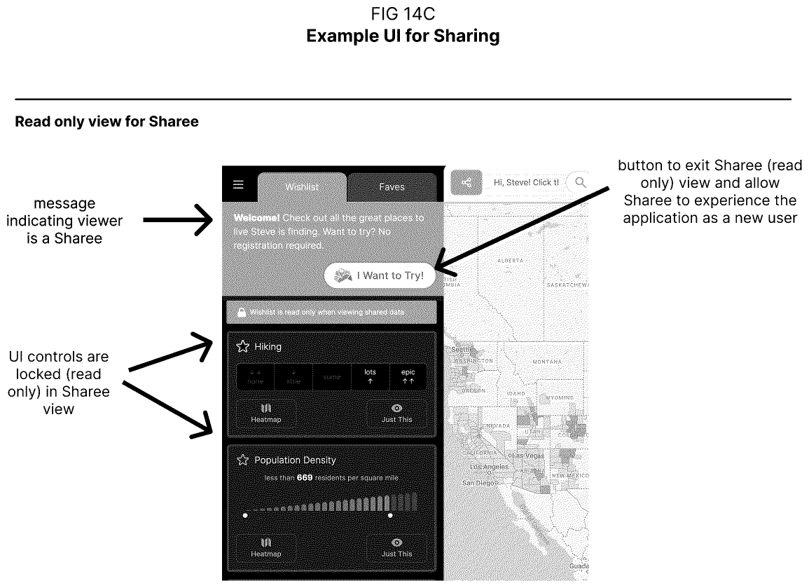

FIG. 14A is an example depiction of a button feature allowing the user to share their experience and data, in accordance with an implementation. When considering something as meaningful as a move, it is often prudent to seek the counsel of trusted friends or family.

FIG. 14B is an example depiction of sharing options available to a user, in accordance with an implementation. In one aspect, the options would include the ability to share on multiple social media platforms. In one aspect, the options would include the ability to share via email. In one aspect, the options would include the ability to select the information may choose to share. In one aspect, one of the elements of sharable information would be the wishlist 301 and corresponding match list 304. In one aspect, one of the sharable elements would be the favorites list (see FIGS. 11A and 11B).

FIG. 14C is an example depiction of a sharee experience after accepting the invitation to explore from the original sharing user, in accordance with an implementation. In one aspect the sharee is presented the sharing user's experience, but will all UI controls locked so they cannot edit the sharing user's experience. That is, the sharee will be presented with a read-only experience. In one aspect, the sharee is offered the opportunity to try the website themselves in a full read/write manner without altering the sharing user's account. In one aspect, the sharing user may establish several different profiles under a single account so they can share different results with different sharees.

### XVIII. Implementation Mechanisms, Alternatives & Extensions

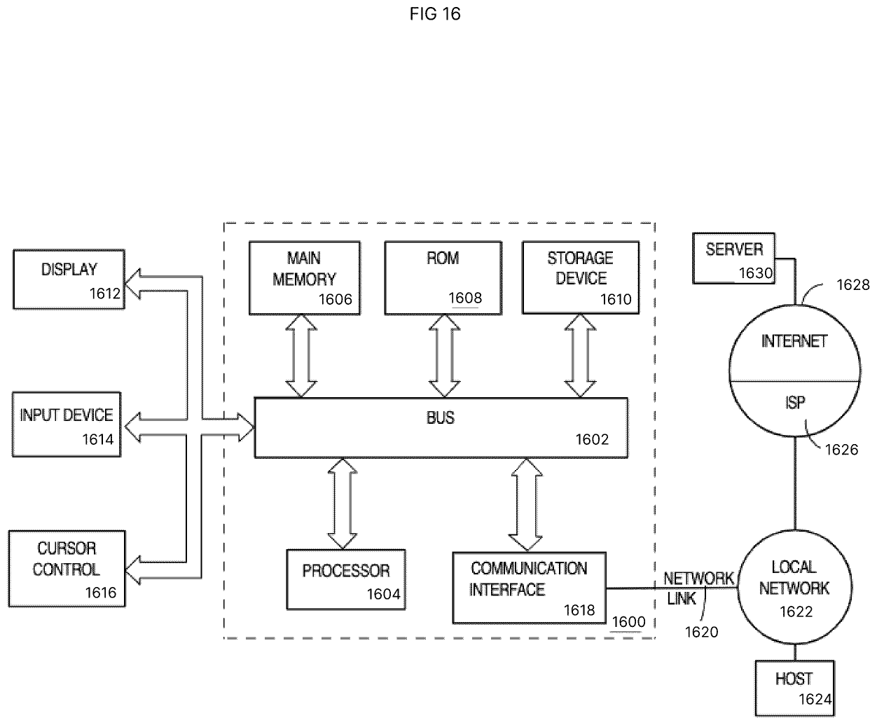

The approach described herein for helping prospective movers interactively discover and explore ideal personalized living locations is applicable to a variety of contexts and implementations and is not limited to a particular context or implementation. FIG. 16 is a block diagram that illustrates a computer system 1600 upon which an implementation may be implemented. Computer system 1600 includes a bus 1602 or other communication mechanism for communicating information, and a processor 1604 coupled with bus 1602 for processing information. Computer system 1600 also includes a main memory 1606, such as a random access memory (RAM) or other dynamic storage device, coupled to bus 1602 for storing information and instructions to be executed by processor 1604. Main memory 1606 also may be used for storing temporary variables or other intermediate information during execution of instructions to be executed by processor 1604. Computer system 1600 further includes a read only memory (ROM) 1608 or other static storage device coupled to bus 1602 for storing static information and instructions for processor 1604. A storage device 1610, such as a magnetic disk or optical disk, is provided and coupled to bus 1602 for storing information and instructions.

Computer system 1600 may be coupled via bus 1602 to a display 1612, such as a cathode ray tube (CRT), for displaying information to a computer user. An input device 1614, including alphanumeric and other keys, is coupled to bus 1602 for communicating information and command selections to processor 1604. Another type of user input device is cursor control 1616, such as a mouse, a trackball, or cursor direction keys for communicating direction information and command selections to processor 1604 and for controlling cursor movement on display 1612. This input device typically has two degrees of freedom in two axes, a first axis (e.g., x) and a second axis (e.g., y), that allows the device to specify positions in a plane.

The invention is related to the use of computer system 1600 for implementing the techniques described herein. According to one implementation, those techniques are performed by computer system 1600 in response to processor 1604 executing one or more sequences of one or more instructions contained in main memory 1606. Such instructions may be read into main memory 1606 from another machine-readable medium, such as storage device 1610. Execution of the sequences of instructions contained in main memory 1606 causes processor 1604 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 1600, various machine-readable media are involved, for example, in providing instructions to processor 1604 for execution. Such a medium may take many forms, including but not limited to, non-volatile media, volatile media, and transmission media. Non-volatile media includes, for example, optical or magnetic disks, such as storage device 1610. Volatile media includes dynamic memory, such as main memory 1606. Transmission media includes coaxial cables, copper wire and fiber optics, including the wires that comprise bus 1602. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 1604 for execution. For example, the instructions may initially be carried on a magnetic disk of a remote computer. The remote computer can load the instructions into its dynamic memory and send the instructions over a telephone line using a modem. A modem local to computer system 1600 can receive the data on the telephone line and use an infra-red transmitter to convert the data to an infra-red signal. An infra-red detector can receive the data carried in the infra-red signal and appropriate circuitry can place the data on bus 1602. Bus 1602 carries the data to main memory 1606, from which processor 1604 retrieves and executes the instructions. The instructions received by main memory 1606 may optionally be stored on storage device 1610 either before or after execution by processor 1604.

Computer system 1600 also includes a communication interface 1618 coupled to bus 1602. Communication interface 1618 provides a two-way data communication coupling to a network link 1620 that is connected to a local network 1622. For example, communication interface 1618 may be an integrated services digital network (ISDN) card or a modem to provide a data communication connection to a corresponding type of telephone line. As another example, communication interface 1618 may be a local area network (LAN) card to provide a data communication connection to a compatible LAN. Wireless links may also be implemented. In any such implementation, communication interface 1618 sends and receives electrical, electromagnetic or optical signals that carry digital data streams representing various types of information.

Network link 1620 typically provides data communication through one or more networks to other data devices. For example, network link 1620 may provide a connection through local network 1622 to a host computer 1624 or to data equipment operated by an Internet Service Provider (ISP) 1626. ISP 1626 in turn provides data communication services through the world wide packet data communication network now commonly referred to as the “Internet” 1628. Local network 1622 and Internet 1628 both use electrical, electromagnetic or optical signals that carry digital data streams. The signals through the various networks and the signals on network link 1620 and through communication interface 1618, which carry the digital data to and from computer system 1600, are exemplary forms of carrier waves transporting the information.

Computer system 1600 can send messages and receive data, including program code, through the network(s), network link 1620 and communication interface 1618. In the Internet example, a server 1630 might transmit a requested code for an application program through Internet 1628, ISP 1626, local network 1622 and communication interface 1618.

The received code may be executed by processor 1604 as it is received, and/or stored in storage device 1610, or other non-volatile storage for later execution. In this manner, computer system 1600 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method comprising:
receiving a request to provide relocation candidates based on an initial search query;
causing display of example locations that match the initial search query;
adding one or more selected locations from the example locations to a list of reference locations;
generating a correlation list of ranked attributes based on the list of reference locations;
receiving one or more priority attributes selected from the correlation list of ranked attributes; and
causing display of the relocation candidates based on matching the one or more priority attributes to a plurality of potential locations.

2. The method of claim 1, wherein generating the correlation list of ranked attributes is based on evaluating a correlation of each of a plurality of attributes applied across the list of reference locations.

3. The method of claim 2, wherein evaluating the correlation is based on minimum and maximum values of the plurality of attributes applied across the list of reference locations.

4. The method of claim 1, wherein the relocation candidates are matched based on a weighted average of the one or more priority attributes applied to the plurality of potential locations.

5. The method of claim 1, wherein the relocation candidates are matched based on filtering the plurality of potential locations using threshold value ranges for the one or more priority attributes.

6. The method of claim 1, wherein the initial search query comprises one or more text search terms.

7. The method of claim 1, wherein the display of the relocation candidates comprises at least one of: a text list or a heatmap.

8. A device comprising a processor configured to:
receive a request to provide relocation candidates based on an initial search query;
cause display of example locations that match the initial search query;
add one or more selected locations from the example locations to a list of reference locations;
generate a correlation list of ranked attributes based on the list of reference locations;
receive one or more priority attributes selected from the correlation list of ranked attributes; and
cause display of the relocation candidates based on matching the one or more priority attributes to a plurality of potential locations.

9. The device of claim 8, wherein generating the correlation list of ranked attributes is based on evaluating a correlation of each of a plurality of attributes applied across the list of reference locations.

10. The device of claim 9, wherein evaluating the correlation is based on minimum and maximum values of the plurality of attributes applied across the list of reference locations.

11. The device of claim 8, wherein the relocation candidates are matched based on a weighted average of the one or more priority attributes applied to the plurality of potential locations.

12. The device of claim 8, wherein the relocation candidates are matched based on filtering the plurality of potential locations using threshold value ranges for the one or more priority attributes.

13. The device of claim 8, wherein the initial search query comprises one or more text search terms.

14. The device of claim 8, wherein the display of the relocation candidates comprises at least one of: a text list or a heatmap.

15. One or more computer-readable media storing instructions which, when processed by one or more processors, implement a method comprising:
receiving a request to provide relocation candidates based on an initial search query;
causing display of example locations that match the initial search query;
adding one or more selected locations from the example locations to a list of reference locations;
generating a correlation list of ranked attributes based on the list of reference locations;
receiving one or more priority attributes selected from the correlation list of ranked attributes; and
causing display of the relocation candidates based on matching the one or more priority attributes to a plurality of potential locations.

16. The one or more computer-readable media of claim 15, wherein generating the correlation list of ranked attributes is based on evaluating a correlation of each of a plurality of attributes applied across the list of reference locations.

17. The one or more computer-readable media of claim 16, wherein evaluating the correlation is based on minimum and maximum values of the plurality of attributes applied across the list of reference locations.

18. The one or more computer-readable media of claim 15, wherein the relocation candidates are matched based on a weighted average of the one or more priority attributes applied to the plurality of potential locations.

19. The one or more computer-readable media of claim 15, wherein the relocation candidates are matched based on filtering the plurality of potential locations using threshold value ranges for the one or more priority attributes.

20. The one or more computer-readable media of claim 15, wherein the initial search query comprises one or more text search terms.
